(19) United States
(12) Patent Application Publication
(10) Pub. No.: US 2016/0256011 A1
(43) Pub. Date: Sep. 8, 2016

(54) Tapered Colander

(71) Applicants: Sandra Monroe, Haverhill, MA (US); Jim Wilkinson, Hampstead, NH (US)

(72) Inventors: Sandra Monroe, Haverhill, MA (US); Jim Wilkinson, Hampstead, NH (US)

(21) Appl. No.: 15/019,471

(22) Filed: Feb. 9, 2016

Related U.S. Application Data
(60) Provisional application No. 62/127,318, filed on Mar. 3, 2015.

(51) Int. Cl. A47J 43/24

(52) U.S. Cl. CPC A47J 43/24

(57) ABSTRACT

A colander configured to adapt to various sized containers. The colander is designed to prevent contact with unclean surfaces thus preventing contamination of food. The colander is designed for “hands-free” use, namely the draining and rinsing of food. A double-walled colander with tapered sidewalls that is capable of straining food in both an upright and an upside down orientation. A stackable, dishwasher safe colander.

### CROSS REFERENCE TO RELATED APPLICATIONS

This Application claims the benefit of U.S. Provisional Application No. 62/127,318, filed Mar. 3, 2015, the contents of which are incorporated by reference herein in their entirety.

### FIELD OF THE DISCLOSURE

The present disclosure relates to stackable colanders and more particularly to tapered colanders for use with different sized cans, where the colander of the present disclosure prevents food contamination resulting from contact with unclean surfaces.

### BACKGROUND OF THE DISCLOSURE

Colanders are typically shaped like a howl and have a variety of different sized perforations or slits throughout the walls of the bowl that allow liquid to flow out of the bowl leaving rinsed and/or drained food in the bowl, When the colander is set into a sink, as is often the case, the contents of the bowl are often rinsed again before serving or cooking. When a typical colander is set into a sink to drain and/or rinse food, the food is in close proximity to the surface of the sink, which is one of the most contaminated places in your home due, in part, to cross contamination.

In some existing colanders there is a pedestal on the base of the bowl to allow the colander to sit on a flat surface without falling over due to the spherical profile of the colander. Some colanders also have handles protruding from the sides of the bowl to make carrying the bowl-shaped colander easier.

One problem with current colander designs is that the food is in close contact with contaminated surfaces during use Additionally, food items are often scooped out of their original container, e.g., a can, and placed into the colander so that they can be rinsed. This introduces the potential for additional contamination. Furthermore, due to the shape of current colander designs the food is often moved into another container prior to cooking so that the colander can be reused and/or so that the food is not left in the sink for an extended period of time where it would become further contaminated during meal preparation.

Other current colander designs that are adapted to fit onto a standard size can do not provide a barrier to contaminated surfaces in the kitchen. These colanders are typically either fiat on the bottom, which would cause the colander to rest directly on an unclean surface, or the colanders are snapped onto a can and are rounded inward so that the can is set directly on a surface, thus contaminating the food to be strained.

In contrast, colanders of the present disclosure are configured to accept various sized cans so that the can, or other original food container, is tipped over to drain and then filled with water to rinse and then tipped over along with the colander to drain the food while keeping the food far from any contaminated surfaces. The rinsed and/or drained food may continue to be stored in the original container until used for cooking or eating, thus preventing contamination and making the colander available for further use by simply inverting the colander to its starting position. The colander of the present disclosure allows for “hands free” use while preventing cross contamination. Additionally, the colander of the present disclosure is configured to be stackable to save valuable space when stored and/or when in transit.

### SUMMARY OF THE DISCLOSURE

It has been recognized that colanders are used to strain and/or rinse food prior to eating or cooking It has also been recognized that colanders are typically used in or near a kitchen sink, which is one of the least sanitary places in your home.

One aspect of the present disclosure is a colander comprising, an inner vessel comprising a first side wall with a top and a bottom, wherein the first side wall of the inner vessel is adapted to accept an end of a cylinder and an outer vessel comprising a second side wall with a top and a bottom, wherein the top of the outer vessel merges with the top of the inner vessel thereby forming a double-walled colander, and wherein the bottom of the second side wall extends beyond the bottom of the first side wall and is configured to rest on a flat surface.

One embodiment of the colander is wherein the first side wall and the second side wall each have an inside surface and an outside surface.

One embodiment of the colander is wherein the bottom of the inner vessel further comprises a plurality of perforations that allow liquid to travel from the inside surface to the outside surface of the inner vessel.

One embodiment of the colander is wherein the outer vessel further comprises a plurality of perforations that allow liquid to travel from the cavity formed between the outer surface of the inner vessel and the inner surface of the outer vessel.

One embodiment of the colander is wherein the top of the first side wall has a first circumference and the bottom of the first side wall has a second circumference and the second circumference of the first side wall is smaller than the first circumference of the first side wall forming a tapered inner vessel.

One embodiment of the colander is wherein the top of the second side wall has a first circumference and the bottom of the second side wall has a second circumference and the second circumference of the second side wall is larger than the first circumference of the second side wall forming a tapered outer vessel.

One embodiment of the colander further comprises one or more handles located on second side wall.

One embodiment of the colander is wherein the colander comprises food-grade plastic. One embodiment of the colander is wherein the colander is dishwasher safe.

One embodiment of the colander is wherein the top of the outer vessel and the top of the inner vessel comprises one or more protrusions configured to allow the colander to rest on a flat surface when inverted.

One embodiment of the colander is wherein the second side wall is printed.

Another aspect of the present disclosure is a colander comprising, an inner vessel comprising a first side wall with a top and a bottom, wherein the first side wall of the inner vessel is adapted to accept an end of a cylinder and the bottom of the inner vessel further comprises a plurality of perforations that allow liquid to travel from the inside surface to the outside surface of the inner vessel; and an outer vessel comprising a second side wall with a top and a bottom, wherein the top of the outer vessel merges with the top of the inner vessel thereby forming a double-walled colander, wherein the first side wall and the second side wall each have an inside surface and an outside surface and wherein the bottom of the second side wall extends beyond the bottom of first side wall and is configured to rest on a flat surface.

One embodiment of the colander is wherein the outer vessel further comprises a plurality of perforations that allow liquid to travel from the cavity formed between the outer surface of the inner vessel and the inner surface of the outer vessel.

One embodiment of the colander is wherein the top of the first side wall has a first circumference and the bottom of the first side wall has a second circumference and the second circumference of the first side wall is smaller than the first circumference of the first side wall forming a tapered inner vessel.

One embodiment of the colander is wherein the top of the second side wall has a first circumference and the bottom of the second side wall has a second circumference and the second circumference of the second side wall is larger than the first circumference of the second side wall forming a tapered outer vessel.

One embodiment of the colander further comprises one or more handles located on the second side wall.

One embodiment of the colander is wherein the colander comprises food-grade plastic. One embodiment of the colander is wherein the colander is dishwasher safe.

One embodiment of the colander is wherein the top of the outer vessel and the top of the inner vessel comprises one or more protrusions configured to allow the colander to rest on a flat surface when inverted.

One embodiment of the colander is wherein the second side wall is printed.

These aspects of the disclosure are not meant to be exclusive and other teatimes, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows one embodiment of the colander of the present disclosure with a can inserted.

FIG. 2 shows one embodiment of the colander of the present disclosure in a stacked arrangement.

FIG. 3 shows one embodiment of the colander of the present disclosure that is adaptable to accept a variety of can sizes and is usable when inverted.

FIG. 4 shows one embodiment of the colander of the present disclosure looking down on the colander when it is flipped over (e.g., looking up from the bottom).

FIG. 5 shows a cross section of one embodiment of the colander of the present disclosure.

FIG. 6 shows one embodiment of the colander of the present disclosure looking down on the top of the colander.

FIG. 7A shows one embodiment of the colander of the present disclosure.

FIG. 7B shows one embodiment of the colander of the present disclosure.

FIG. 8 shows one embodiment of the colander of the present disclosure.

FIG. 9 shows one embodiment of the colander of the present disclosure.

### DETAILED DESCRIPTION OF THE DISCLOSURE

Colanders are often bowl-shaped and have a variety of different sized perforations in the walls of the bowl that allow liquid to flow out of the bowl while leaving the rinsed and/or drained food in the bowl. Colanders are often used in a sink to allow liquid to drain away, but that creates an opportunity for the food to become contaminated due to unsanitary conditions. Instances of cross contamination between foods are also highly likely with current systems because of their open design. Additionally, food items that need to be strained are often scooped out of their original container, e.g., a can, and placed into the colander so that they can be sufficiently rinsed and/or drained. This transfer introduces the potential for additional contamination. A third opportunity for contamination using current systems is when the food that has been strained and/or rinsed is transferred to another container to await further cooking or consumption. The current process creates a series of occasions fur food to become contaminated and potentially make someone ill. Instances of food poisoning are of great concern, particularly for children and those who may be immunocompromised.

Other colanders that are designed to fit, or snap onto, a standard size can also have issues with exposing food to unclean surfaces. These colanders are typically either flat on the bottom, which would then rest directly on an unclean surface, or they are rounded inward so that if they are set on a surface the colander is set directly on the surface thus contaminating the food to be strained,

In certain embodiments of the colander of the present disclosure, the colander is configured to accept various sized cans so that the can, or other original food container, may be drained and then filled with water to rinse the contents of the container. The can and colander are then tipped over to drain and/or rinse the food while keeping the food far from any contaminated surfaces. The colander of the present disclosure provides “hands free” use while preventing contamination of the food to be rinsed and/or strained. The rinsed food may be rinsed again and/or stored in the original container until it is used for cooking or eating, thus preventing contamination and making the colander available for further use by simply inverting the colander to its starting position. Rinsing and draining foods has been shown to reduce sodium content up to about 40%, which provides for a healthier diet. The colander of the present disclosure makes rinsing and draining food easier and more efficient.

Using current colanders often requires people to leave the colander open in the sink with the contents exposed. This method renders the sink, essentially useless or one must risk contaminating the food in the colander when preparing, cleaning, or rinsing other foods or by rinsing or washing their hands. The present system keeps the food contained in its original container while rinsing and/or draining the food. The food can remain in the original container even after rinsing and draining so the sink can be freed up for other use and the colander can be used to drain and/or rinse another food item. The colander of the present disclosure provides for minimal preparation steps, no transfer of food from one container to another container, or the use of additional utensils, all of which could introduce contamination. As noted previously, the colander of the present disclosure also provides for “hands free” use making food preparation faster and easier.

In certain embodiments of the colander of the present disclosure, the colander is configured to be stackable to save valuable space in the kitchen or on shelves where the colanders are to be sold. Saving space while in transit is also a valuable feature of this system so that overall production and distribution costs can be reduced,

In certain embodiments, the colander has one or more handles. In certain embodiments, the handles may be in the form of loops. In certain embodiments, the handles may be protrusions. In certain embodiments, the handles may be indentations. In certain embodiments, the handles may formed by cutaways in the outer vessel. It is understood that handles ma be constructed in a variety of sizes and shapes depending on the desired application.

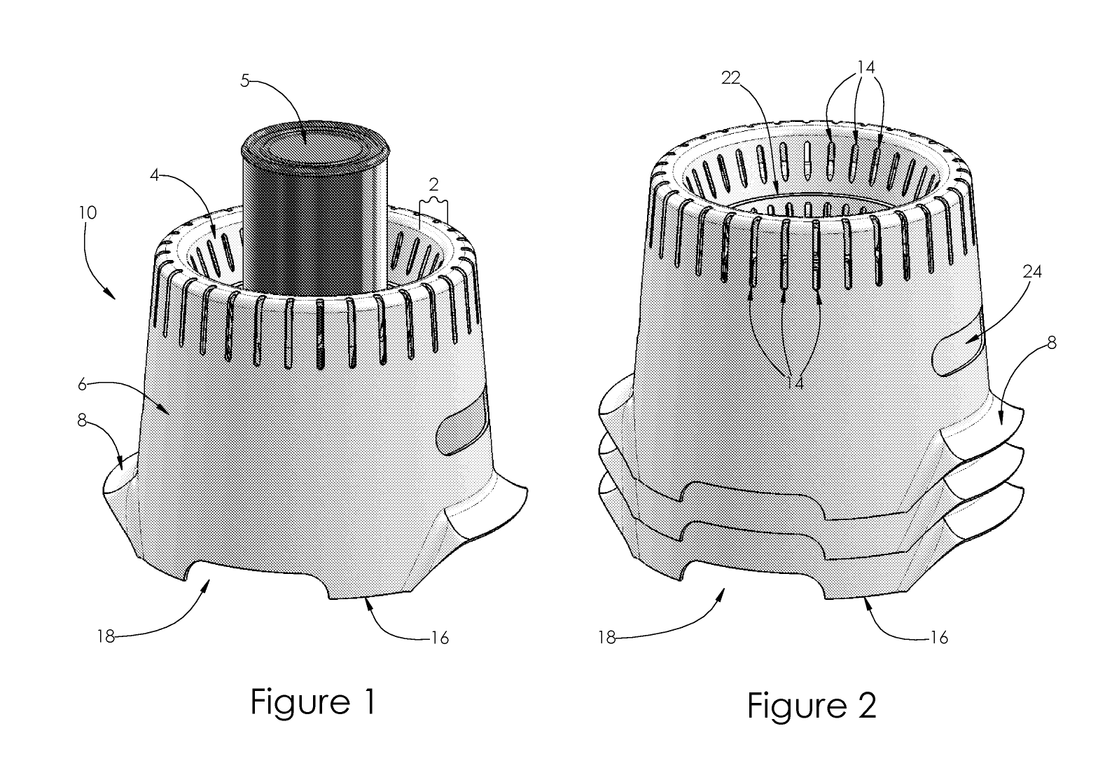

Referring to FIG. 1, one embodiment of the colander of the present disclosure is shown with a can inserted. More specifically, a colander 10 is shown with a can 5 inserted into the top 2 of the inner vessel 4. In certain embodiments of the present disclosure, the outer vessel 6 further comprises handles 8. In certain embodiments, the inner vessel is configured to accept a large range of can sizes. In certain embodiments of the colander of the present disclosure, the inner vessel is configured to accept a small range of can sizes.

In certain embodiments of the present disclosure, the inner vessel is configured to accept a can with an outer diameter ranging from about 2 inches to about 7 inches. In certain embodiments of the present disclosure, the inner vessel is configured to accept a can with an outer diameter ranging from about 2. inches to about 6 inches. In certain embodiments of the present disclosure, the inner vessel is configured to accept a can with an outer diameter ranging from about 2 inches to about 5 inches. In certain embodiments of the present disclosure, the inner vessel is configured to accept a can with an outer diameter ranging from about 2 inches to about 4 inches. In certain embodiments of the present disclosure, the inner vessel is configured to accept a can with an outer diameter ranging from about 3 inches to about 7 inches. In certain embodiments of the present disclosure, the inner vessel is configured to accept a can with an outer diameter ranging from about 4 inches to about 7 inches.

in certain embodiments of the present disclosure, the inner vessel is configured to accept a can with an outer diameter of about 2 inches, about 2 1/16 inches, about 2⅛ inches, about 2 3/16 inches, about 2¼ inches, about 2 5/16 inches, about 2⅜ inches. about 2 7/16 inches, about 2½ inches, about 2 9/16 inches, about 2⅝ inches, about 2 11/16 inches, about 2¾ inches, about 2 13/16 inches, about 2⅞ inches, or about 2 15/16 inches. In certain embodiments of the present disclosure, the inner vessel is configured to accept a can with an outer diameter of about 3 inches, about 3 1/16 inches, about 3⅛ inches, about 3 3/16 inches, about 3¼ inches, about 3 5/16 inches, about 3⅜ inches, about 3 7/16 inches, about 3½ inches, about 3 9/16 inches, about 3⅝ inches, about 3 11/16 inches, about 3¾ inches, about 3 13/16 inches, about 3⅞ inches, or about 3 15/16 inches, in certain embodiments of the present disclosure, the inner vessel is configured to accept a can with an outer diameter of about 4 inches, about 4 1/16 inches, about 4⅛ inches, about 4 3/16 inches, about 4¼ inches, about 4 5/16 inches, about 4⅜ inches, about 4 7/16 inches, about 4½ inches, about 4 9/16 inches, about 4⅝ inches, about 4 11/16 inches, about 4¾ inches, about 4 13/16 inches, about 4⅞ inches, or about 4 15/16 inches. In certain embodiments of the present disclosure, the inner vessel is configured to accept a can with an outer diameter of about 5 inches, about 5 1/16 inches, about 5⅛ inches, about 5 3/16 inches, about 5¼ inches, about 5 5/16 inches, about 5⅜ inches, about 5 7/16 inches, about 5½ inches, about 5 9/16 inches, about 5 5/8 inches, about 5 11/16 inches, about 5¾ inches, about 5 13/16 inches, about 5⅞ inches, or about 5 15/16 inches. In certain embodiments of the present disclosure, the inner vessel is configured to accept a can with an outer diameter of about 6 inches, about 6 1/16 inches, about 6⅛ inches, about 6 3/16 inches, about 6¼ inches, about 6 5/16 inches, about 6⅜ inches, about 6 7/16 inches, about 6½ inches, about 6 9/16 inches, about 6⅝ inches, about 6 11/16 inches, about 6¾ inches, about 6 13/16 inches, about 6⅞ inches, or about 6 15/16 inches.

Referring to FIG. 2, one embodiment of the colander of the present disclosure in a stacked arrangement is shown. More specifically, the side walls of the colander are configured so that multiple colanders can be stacked for easy shipping and/or storage. In certain embodiments, the colander has handles 8. In certain embodiments, the protruded handles 8 also to aid in separation of members of the stack and aid in drainage when the colander of the present disclosure is on the flat surface. In certain embodiments, protruding handles are preferably located toward the bottom of the outer vessel so the colanders may be stacked in such a way as to minimize space when shipped and/or stored. In certain embodiments, the bottom of the outer vessel has one or more protrusions 16 that are configured to allow the colander to sit on a flat surface. In certain embodiments, a protrusion can be used to help separate colanders from a stacked arrangement. In certain embodiments of the present disclosure, the second side wall comprises cutaways 18 that can be used to help promote draining. In certain embodiments, the outer vessel 6 has one or more indentations (not shown) that can be used as handles and/or to help separate the colanders when stacked. In certain embodiments of the colander of the present disclosure, the outer vessel has larger perforations 24, or cutaways, that may be used as handles.

Still referring to FIG. 2, in certain embodiments the colander comprises ridges 22 that are adapted to accept a container, or can, of a particular size. In certain embodiments, there is a plurality of perforations 14 throughout various regions of the colander depending on the desired application.

In certain embodiments of the colander of the present disclosure, the colander is dishwasher safe. In certain embodiments, the colander comprises metal, In certain embodiments the colander comprises food-grade plastic. In certain embodiments of the present disclosure, the colander is constructed of materials selected from the group consisting of polyethylene terphthalate, high-density polyethylene, polyvinyl chloride, low-density polyethylene, polypropylene, polystyrene, and the like.

In certain embodiments of the colander of the present disclosure, the colander is manufactured by stamping, extruding, injection molding, blow molding, 3-D printing, and the like.

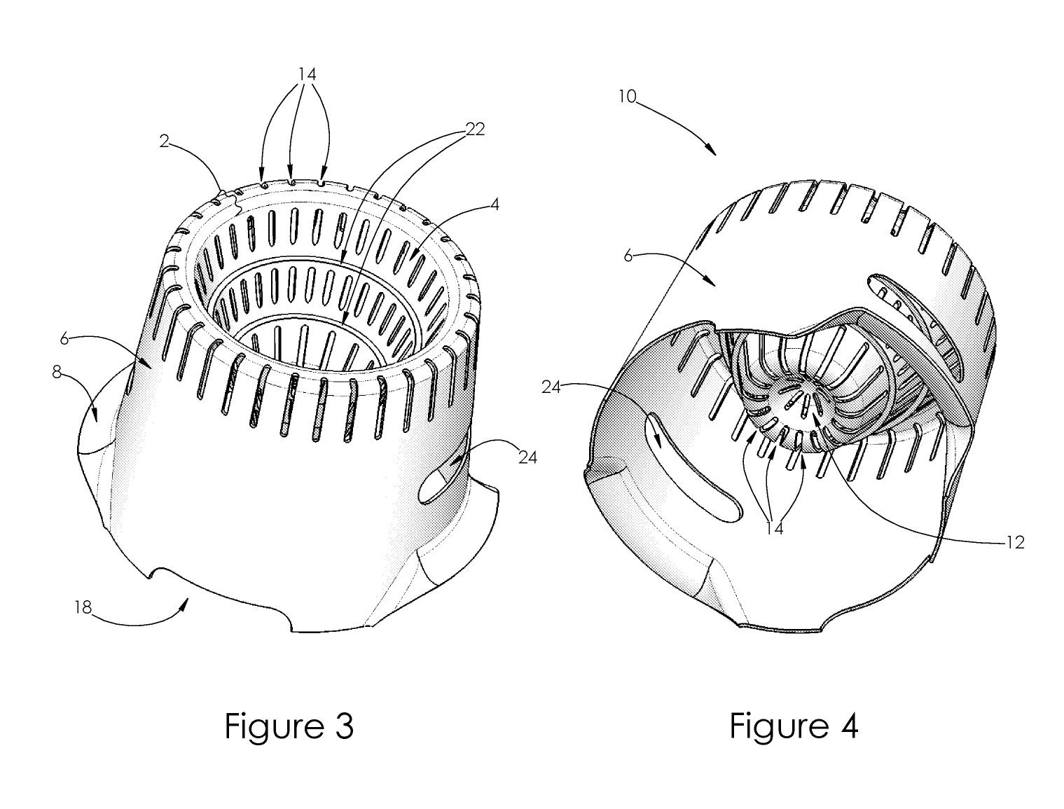

Referring to FIG. 3, one embodiment of the colander of the present disclosure is shown. More specifically, the colander 10 has an inner vessel 4 having a top 2 and a bottom (not shown). In certain embodiments of the colander of the present disclosure, the bottom and sidewalls of the inner vessel comprise perforations that allow liquid to flow from the inside the inner vessel to the outside of the inner vessel. In certain embodiments of the disclosure, the inner vessel comprises a plurality of perforations 14 arranged throughout the top of the inner vessel. As used herein, a perforation includes but is not limited to a hole, a slit, and the like.

Referring to FIG. 4, one embodiment of the colander of the present disclosure looking down on the colander when it is flipped over (e.g., looking up from the bottom) is shown, More specifically, the colander 10 is inverted so that the bottom 12 of the inner vessel is visible. The drawing shows one embodiment of perforations 14 in the bottom of the inner vessel. It is understood that the plurality of perforations could be of varying sizes, the same size, arranged in a multitude of patterns, and may be comprised of a variety of shapes including, but not limited to, circles, dots, ovals, strips, squares, diamonds, and the like. In certain embodiments of the present disclosure, the plurality of perforations may form a mesh.

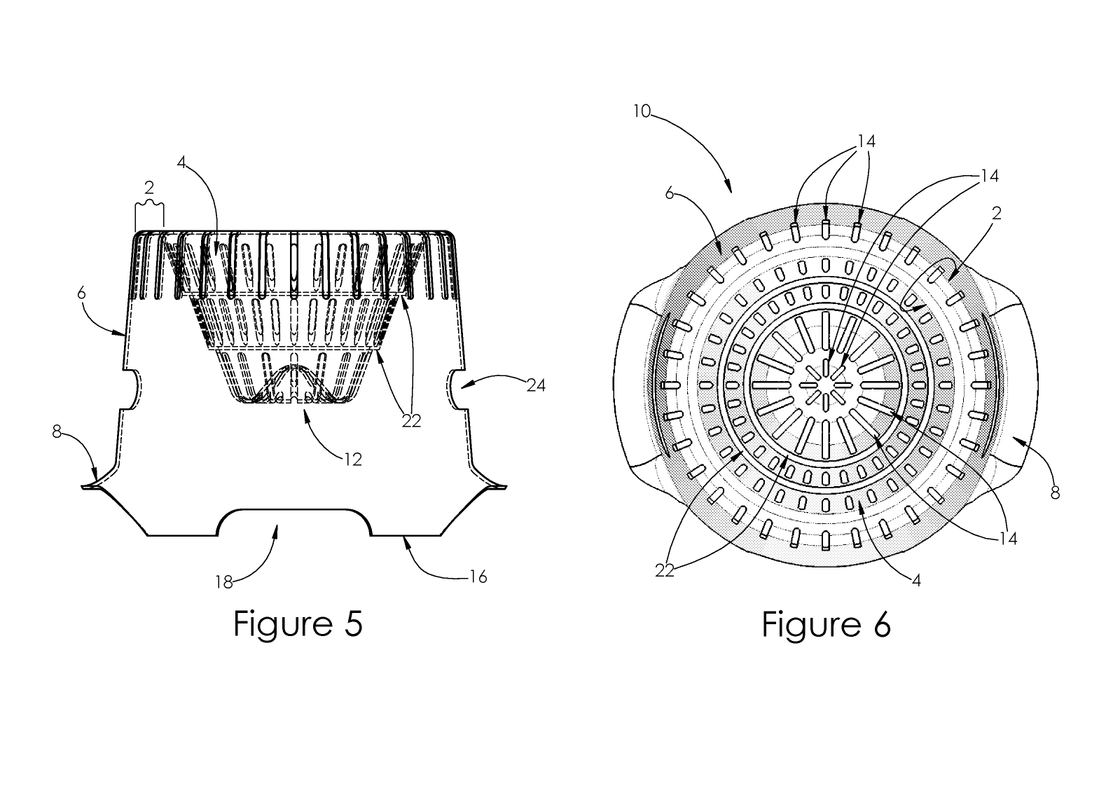

Still referring to FIG. 4, in certain embodiments, the inner vessel has a flat bottom. In certain embodiments of the present disclosure the inner vessel has a rounded bottom. In certain embodiments, the inner vessel has a convex surface when viewed from below. hi certain embodiments of the present disclosure, the inner vessel has a concave surface when viewed from below. In certain embodiments of the present disclosure, the inner vessel has both a convex and a concave surface when viewed from below as shown in FIG. 4 and FIG. 5.

In certain embodiments, the configuration of the bottom on the inner vessel, as shown in FIGS. 4 and 5, further facilitates the rinsing and draining of the food while it remains in its original container. In certain embodiments of the colander of the present disclosure, the concave bottom is primarily to “focus” or “funnel” water into the can during water fills so it fills faster and to minimize water spilling over the edges of the inner vessel and into the inverted colander. In certain embodiments, perforations are added on the very top to help drain this spillage. In certain embodiments, the concave surface also acts as a good “visual target” for the user who is aiming the faucet water to fill the can since it may be difficult to see the can through the colander.

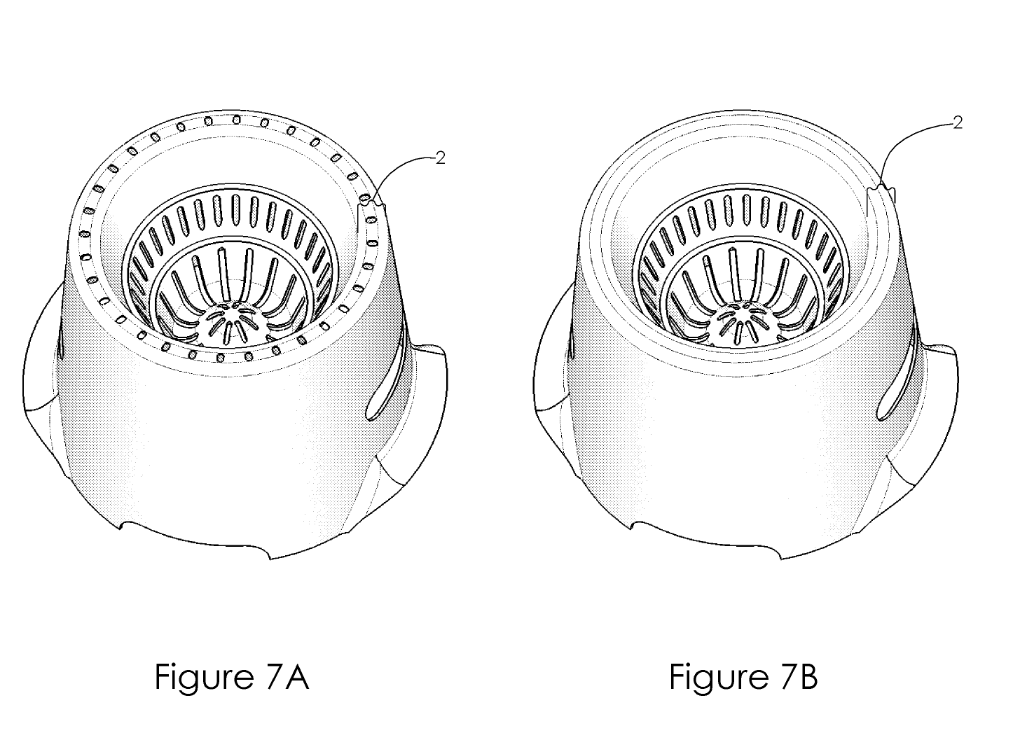

Referring to FIG. 5, a cross section of one embodiment of the colander of the present disclosure is shown. More specifically, the top 2 of the inner vessel 4 and the outer vessel 6 come together to form a double-walled system. In certain embodiments, the colander 10 is shown looking down at the top 2 of the colander were the top merges the inner vessel side wall 4 with the outer vessel side wall 6. See also, FIGS. 6, 7A and 7B. In certain embodiments, the top 2 has a width, In certain embodiments of the present disclosure, the to of the colander 2 may be rounded across its width. In certain embodiments, the top of the colander 2 may be flat across its width. In yet other embodiments, the top of the colander 2 may have one or more raised regions around the circumference of the top that may act as a pedestal when the colander is inverted.

Still referring to FIG. 5, the outer vessel 6 has one or more protrusions 16 along the bottom that are configured to allow the colander sit flat on a surface. In certain embodiments, the colander of the present disclosure is adaptable to a variety of can sizes. More specifically, in certain embodiments of the disclosure, the inner vessel side wall 4 of the colander is configured to be tapered. In certain embodiments, the inner vessel further comprises ridges 22 configured to accept the rim of a can of a particular size. In certain embodiments of the disclosure, the inner vessel comprises perforations arranged throughout the top, bottom, and side wall of the inner vessel. In certain embodiments of the present disclosure, the outer vessel comprises cutaways 18 that can be used to help with drainage. In certain embodiments, the outer vessel 6 has one or more indentations (not shown) or protrusions 8 that can be used as handles, to help separate the colanders when stacked and/or to help with drainage. In certain embodiments, the outer vessel comprises cutaways in the second side wall 24 that can be used as handles.

Referring to FIG. 6, one embodiment of the colander of the present disclosure is shown looking down at the top. In certain embodiments, there is a plurality of perforations distributed in a variety of patterns and/or sizes throughout various regions of the colander. The perforations may be in the top and/or in the bottom or sidewall of the inner vessel, just to name a few. In this figure, the top 2 is represented as having a width.

Referring to FIG. 7A and FIG. 7B, embodiments of the colander of the present disclosure are shown. More particularly, FIG. 7A shows perforations in the top so the colander such that the colander can be used when inverted. It is understood that the plurality of perforations could be of varying sizes, the same size, arranged in a multitude of patterns, and may be comprised of a variety of shapes including, but not limited to, circles, dots, ovals, strips, squares, diamonds, and the like. In certain embodiments of the present disclosure, the plurality of perforations may form a mesh, in FIG. 7B, perforations are not present in the top 2 and the colander is used in an upright (non inverted) position.

In certain embodiments of the present disclosure, the top of the first side wall (of the inner vessel) has a first circumference and the bottom of the first side wall has a second circumference. In certain embodiments, the second circumference of the first side wall is smaller than the first circumference of the first side wall forming a tapered inner vessel. Please see FIG. 5 for one such embodiment.

In certain embodiments of the present disclosure, the top of the second side wall (of the outer vessel) has a first circumference and the bottom of the second side wall has a second circumference. In certain embodiments, the second circumference of the second side wall is larger than the first circumference of the second side wall forming a tapered outer vessel. Please see FIG. 5 for one such embodiment.

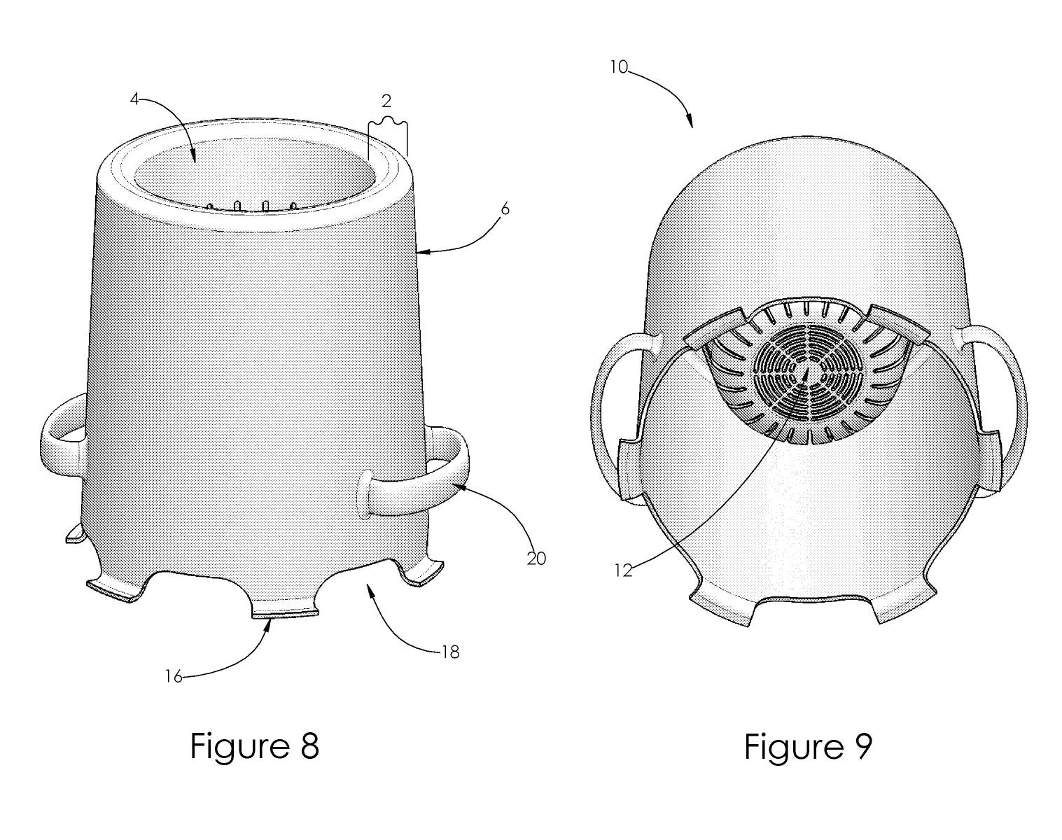

Referring to FIG. 8, one embodiment of the colander of the present disclosure is shown. More specifically, in certain embodiments of the colander of the present disclosure, the bottom of the outer vessel has one or more protrusions 16 that are constructed to allow the colander to sit on a flat surface. In certain embodiments, the outer vessel comprises protrusions 20 that form handles. In certain embodiments of the present disclosure, the second side wall is printed (not shown). In certain embodiments, the printing on the second side wall comprises a measuring chart, a conversion chart, a recipe, household hints, or the like. In certain embodiments, the printing on the second side wall is customizable. In certain embodiments, the customized printing represents a promotion, a brand, a sports team, and the like.

Referring to FIG. 9, one embodiment of the colander of the present disclosure is shown. More specifically, the colander 10 is inverted so that the bottom 12 of the inner vessel is visible. The drawing shows one embodiment of perforations in the bottom of the inner vessel. In certain embodiments, the inner vessel has a flat bottom. In certain embodiments, the inner vessel has a convex surface when viewed from below, In certain embodiments of the present disclosure, the inner vessel has a concave surface when viewed from below. In certain embodiments, the bottom of the second side wall extends beyond the bottom of first side wall and is configured to rest on a flat surface, thus keeping food away from unsanitary surfaces and/or facilitating draining.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A colander comprising,
an inner vessel comprising a first side wall with a top and a bottom, wherein the first side wall of the inner vessel is adapted to accept an end of a cylinder; and
an outer vessel comprising a second side wall with a top and a bottom, wherein the top of the outer vessel merges with the top of the inner vessel thereby forming a double-walled colander, and wherein the bottom of the second side wall extends beyond the bottom of the first side wall and is configured to rest on a flat surface.

2. The colander of claim 1, wherein the first side wall and the second side wall each have an inside surface and an outside surface.

3. The colander of claim 1, wherein the bottom of the inner vessel further comprises a plurality of perforations that allow liquid to travel from the inside surface to the outside surface of the inner vessel.

4. The colander of claim 1, wherein the outer vessel further comprises a plurality of perforations that allow liquid to travel from the cavity formed between the outer surface of the inner vessel and the inner surface of the outer vessel.

5. The colander of claim 1, wherein the top of the first side wall has a first circumference and the bottom of the first side will has a second circumference and the second circumference of the first side wall is smaller than the first circumference of the first side wall forming a tapered inner vessel.

6. The colander of claim 1, wherein the top of the second side wall has a first circumference and the bottom of the second side wall has a second circumference and the second circumference of the second side wall is larger than the first circumference of the second side wall forming a tapered outer vessel.

7. The colander of claim 1, further comprising one or more handles located on second side wall.

8. The colander of claim 1, wherein the colander comprises food-grade plastic.

9. The colander of claim 1, wherein the colander is dishwasher safe.

10. The colander of claim 1, wherein the top of the outer vessel and the top of the inner vessel comprises one or more protrusions configured to allow the colander to rest on a flat surface when inverted.

11. The colander of claim 1, wherein the second side wall is printed.

12. A colander comprising,
an inner vessel comprising a first side wall with a top and a bottom, wherein the first side wall of the inner vessel is adapted to accept an end of a cylinder and the bottom of the inner vessel further comprises a plurality of perforations that allow liquid to travel from the inside surface to the outside surface of the inner vessel; and
an outer vessel comprising a second side wall with a top and a bottom, wherein the top of the outer vessel merges with the top of the inner vessel thereby forming a double-walled colander, wherein the first side wall and the second side wall each have an inside surface and an outside surface and wherein the bottom of the second side wall extends beyond the bottom of first side wall and is configured to rest on a flat surface.

13. The colander of claim 12, wherein the outer vessel further comprises a plurality of perforations that allow liquid to travel from the cavity formed between the outer surface of the inner vessel and the inner surface of the outer vessel.

14. The colander of claim 12, wherein the top of the first side wall has a first circumference and the bottom of the first side wall has a second circumference and the second circumference of the first side wall is smaller than the first circumference of the first side wall forming a tapered inner vessel.

15. The colander of claim 12, wherein the top of the second side wall has a tint circumference and the bottom of the second side wall has a second circumference and the second circumference of the second side wall is larger than the first circumference of the second side wall forming a tapered outer vessel.

16. The colander of claim 12, further comprising one or more handles located on the second side wall.

17. The colander of claim 12, wherein the colander comprises food-grade plastic.

18. The colander of claim 12, wherein the colander is dishwasher safe.

19. The colander of claim 12, wherein the top of the outer vessel and the top of the inner vessel comprises one or more protrusions configured to allow the colander to rest on a fiat surface when inverted.

20. The colander of claim 12, wherein the second side wall is printed.
